(19) United States
(12) Patent Application Publication
(10) Pub. No.: US 2007/0207734 A1
(43) Pub. Date: Sep. 6, 2007

(54) WIRELESS COMMUNICATION BETWEEN CONTROL DEVICES AND CONTROLLED DEVICES WITHIN A COMMON BOARD AND RF HIGH SIDE COUPLER WITH PLANE POLARIZED ANTENNA

(75) Inventor: Michael A. Briere, Manhattan Beach, CA (US)

Correspondence Address: OSTROLENK FABER GERB & SOFFEN, 1180 AVENUE OF THE AMERICAS, NEW YORK, NY, 100368403, US

(73) Assignee: INTERNATIONAL RECTIFIER CORPORATION, El Segundo, CA (US)

(21) Appl. No.: 11/676,029

(22) Filed: Feb. 16, 2007

Related U.S. Application Data
(60) Provisional application No. 60/774,819, filed on Feb. 17, 2006.

(51) Int. Cl. H04B 7/00

(52) U.S. Cl. 455/41.2; 340/825.72

(57) ABSTRACT

A system having a substrate; at least one first semiconductor device disposed on the substrate and having at least one antenna for sending and receiving a radio frequency (RF) signals; at least one second semiconductor device disposed on the substrate and comprising at least one output stage; and at least one controller having an RF transmitter and optionally a receiver having at least one antenna for sending and optionally receiving the RF signals, the at least one controller being disposed on the substrate and sending the RF signals for controlling the at least one second semiconductor device.

### CROSS-REFERENCE TO RELATED APPLICATION

This application is based on and claims priority to U.S. Provisional Patent Application Ser. No. 60/774,819, filed on Feb. 17, 2006 and entitled WIRELESS COMMUNICATION BETWEEN CONTROL DEVICES AND CONTROLLED DEVICES WITHIN A COMMON BOARD AND RF HIGH SIDE COUPLER WITH PLANE POLARIZED ANTENNA, the entire contents of which are hereby incorporated by reference herein.

### BACKGROUND OF THE INVENTION

The present invention relates to wireless communication between control and controlled devices on a common circuit board or within an integrated circuit or amongst circuit boards in the same plane. More particularly, the present invention relates to integration of a radio frequency (RF) transmitter and/or receiver with a controller and a controlled device, e.g., a driver device and a power-switching device.

For example, the gate or the control electrode of a semiconductor device such as a Metal-Oxide Semiconductor Field-Effect Transistor (MOSFET), Insulated Gate Bipolar Transistor (IGBT), or other transistor can be controlled using RF transmission of control signals, e.g., pulse width modulated (PWM) signals, originating from a controller, e.g., a main PWM controller, disposed on the same circuit board or substrate.

Power switching devices are commonly controlled within a circuit, such as an integrated circuit (IC) with electrical signals being sent to their gate or control electrode via a galvanic or wired connection. This hard-wired device control method is the generally available method. Alternative control methods have been sought after, but no successful alternative has materialized.

Some wireless control methods have been proposed. These methods include, for example, millimeter wave wireless interconnection of electronic components within an enclosed electronic system proposed in U.S. Pat. No. 5,754,948. The millimeter wave transmit/receive ICs are described as being coupled to corresponding separated electronic components mounted on printed circuit boards for transmitting data between the separated electronic components via the transmit/receive ICs.

U.S. Pat. No. 5,621,913 makes an attempt to replace the printed circuit board wiring with wireless communication between semiconductor chips having antennas fabricated from the chip's metallization layer; U.S. Pat. No. 6,718,163 integrates RF transmit/receive circuitry within a microelectronic package of an IC die; U.S. Pat. No. 6,771,935 replaces a conventional hard-wired midplane bus with a wireless bus including an RF or light wave transceiver on each card to avoid mechanical assembly problems and transmission of undesired electrical currents amongst circuit cards or boards; and U.S. Pat. No. 5,335,361 interconnects devices of an IC module by electromagnetic waves.

### SUMMARY OF THE INVENTION

It is an object of the present invention to provide means for communicating between a controller and a controlled device on a common substrate, e.g., a common circuit board or within an integrated circuit. For example, a driver device can have a transmitter/receiver to drive the gate or control electrode of a semiconductor device such as a Metal-Oxide Semiconductor Field-Effect Transistor (MOSFET), Insulated Gate Bipolar Transistor (IGBT) or other transistor using radio frequency (RF) transmission of control signals, e.g., pulse width modulated (PWM) signals originating from the controller. For example, the gate of the MOSFET may be coupled to a radio receiver or a transceiver.

It is another object of the present invention to provide means for controlling electrodes of semiconductor switching devices without the necessity of physically wiring control wires to the electrodes of the semiconductor switching devices. The control electrode of the semiconductor switching device could include a receiver which could be a stand-alone integrated circuit (IC) or a receiver integrated in a power switching device so that it could receive transmitted RF signals.

It is yet another object of the present invention to provide an electronic circuit, for example, on a printed circuit board, wherein electronic control information or data is transmitted via the RF signals without interference.

RF communication can thus take place between components within the same IC chip, in the plane of the same circuit board, and in the plane on separate boards.

Other features and advantages of the present invention will become apparent from the following description of the invention that refers to the accompanying drawings.

In accordance with the present invention, there is provided a system including a substrate, at least one semiconductor device having a radio frequency (RF) receiver for receiving RF signals, the at least one semiconductor device being disposed on the substrate and performing functions in response to the received RF signals; and at least one controller having an RF transmitter, the at least one controller being disposed on the substrate and used for sending the RF signals for controlling the at least one semiconductor device. The transmitters and receivers can be transceivers, in which case two way transmission of signals can be provided.

### BRIEF DESCRIPTION OF THE DRAWINGS

FIG. 1 is a diagram showing a circuit board that include controllers and power devices with RF transmitters and receivers;

FIG. 2 is a diagram showing a horizontal stack of circuit boards that include controllers and power devices with RF transmitters and receivers;

FIG. 3 is a diagram showing a vertical stack of circuit boards that include controllers and power devices with RF transmitters and receivers;

FIG. 4 is a diagram showing a multiphase power converter employing an embodiment of the present invention; and

FIG. 5 is a diagram showing a multiphase power converter employing an alternative embodiment of the present invention where the phase ICs are wired to the output stages.

### DETAILED DESCRIPTION OF EMBODIMENTS OF THE INVENTION

In one embodiment, the invention comprises a power switching device, for example a Metal-Oxide Semiconductor Field-Effect Transistor (MOSFET), Insulated Gate Bipolar Transistor (IGBT), or any other type of a power switching transistor, which may be turned on by a radio receiver. The radio receiver may be connected to a gate or a control electrode of the power transistor.

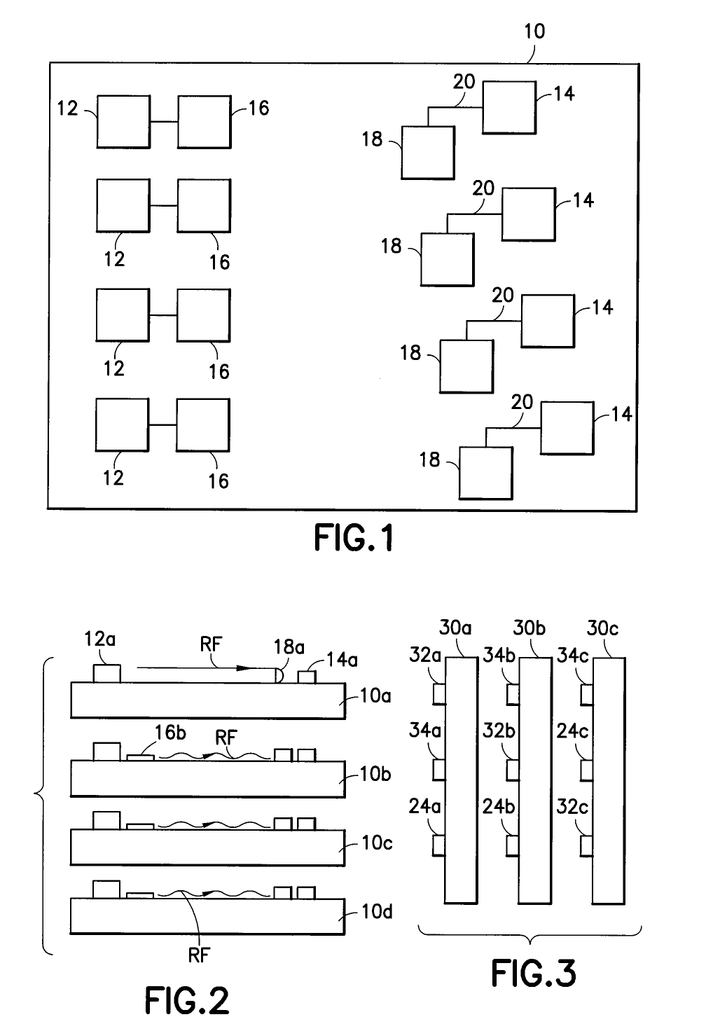

As shown in FIG. 1, a circuit board or an integrated circuit (IC) substrate 10 comprises controllers 12 and power switching devices 14. It further comprises RF transmitters 16 coupled to the controllers 12 and RF receivers 18 coupled to the power switching devices 14. Specifically, the RF receivers 18 are coupled to a gate or a control electrode 20 of the power switching devices 14.

The RF receiver 18 may be integrated with the power-switching device 14 or it may be a separate RF receiver component connected to the control electrode 20 of the power-switching device 14. The RF receiver 18 receives control signals from the RF transmitter 16 of the controller 12. According to an aspect of this embodiment of the invention, the controller 12 coupled to the RF transmitter 16 and the power switching device 14 coupled to the RF receiver 18 are disposed on the same electronic circuit board 10. Accordingly, no control wiring connecting the controllers 12 and the controlled power-switching devices 14 is necessary. The control of the power-switching devices 14 is exercised via the RF control signals. This creates a cheaper, less complex, and more compact structure without the necessity of circuit board leads or wiring or internal IC wiring.

Antennas utilized for the RF transmitter 16 and the RF receiver 18 are preferably plane polarized, that is, they are polarized to operate only in the plane of the circuit board 10 to thereby eliminate circuit board to circuit board interference when circuit boards are placed in a stack, e.g., in a blade server. Thus only the power switching devices 14 on the circuit board 10 will be able to receive the RF signals sent by the controllers 12 positioned on the same board.

An example of an operation of the polarized antennas is shown in FIG. 2. A plurality of circuit boards 10a-10d are stacked horizontally. Each of the circuit boards 10a-10d may include the controllers 12 and the power switching devices 14. The RF signals are sent between the RF transmitters 16 that are coupled to the controllers 12 and the RF receivers 18 that are coupled to the power switching devices 14.

As stated above, the control of the power-switching devices 14 may be exercised via the RF control signals between the RF transmitters 16 coupled to the controllers 12 and the RF receivers 18 coupled to the power switching devices 14. However, the RF signal will only be sent and received within the plane. In FIG. 2, each of the circuit boards 10 constitutes a separate plane. Thus, a RF signal from the controller 12a will only be received by the power switching device 14a and not by any of the power switching devices on the circuit boards 10b-10d.

In another embodiment of the invention, shown in FIG. 3, a plurality of circuit boards 30a-30d may be stacked vertically. Each of the circuit boards 30a-30c may include controllers 32 and power switching devices 24 and 34. The controllers 32 may be coupled to the RF transmitters (not shown) and the power switching devices 24 and 34 may be coupled to the RF receivers (not shown). Utilizing the plane polarized antennas the controller 32a is able to control the power switching devices 34b and 34c and any additional power switching devices located in its horizontal plane on the circuit board 30a. Similarly, the controller 32b is able to control the power switching devices 34a and 24c and the controller 32c is able to control the power switching devices 24a and 24b in their respective horizontal planes.

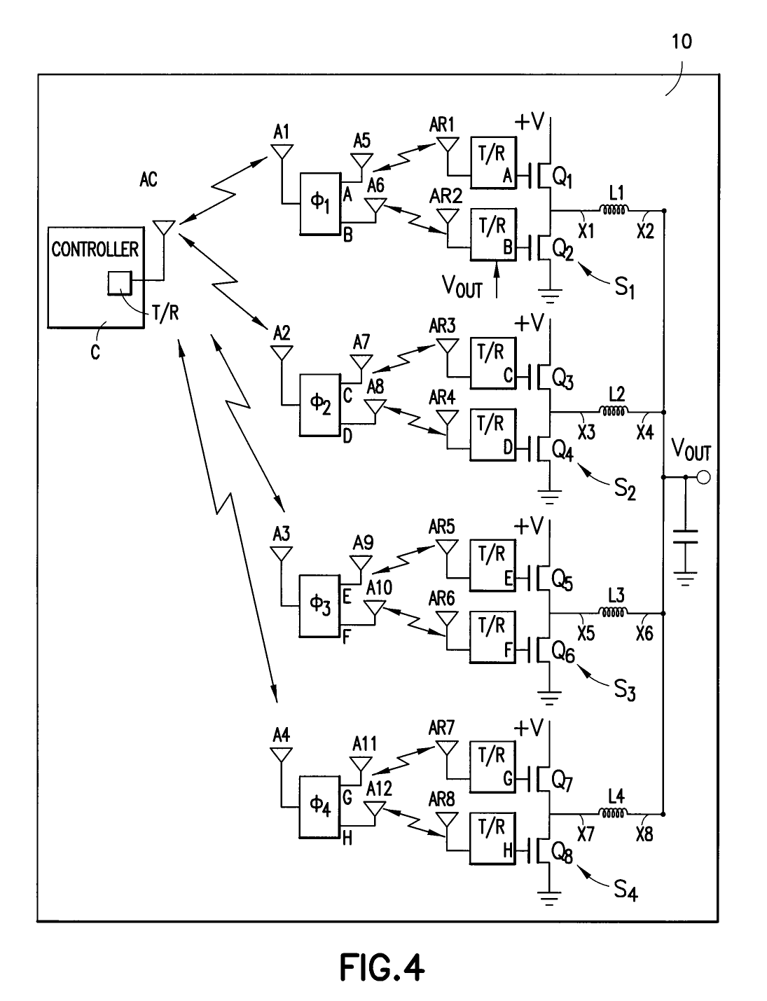

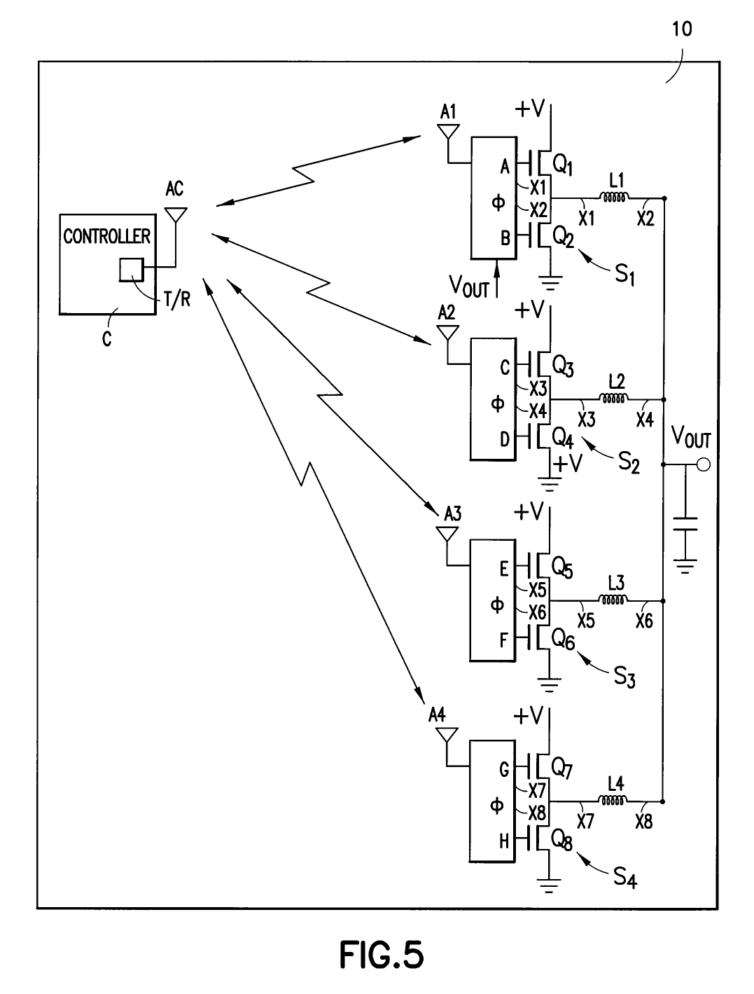

FIG. 4 shows another example of the invention employed in a parallel-connected switching regulator, for example, a multiphase DC-DC power converter that provides an output voltage V_{OUT} from an input voltage +V. For example, International Rectifier Corporation supplies a family of ICs known as the X-phase family for designing multiphase power supply converter circuits. These ICs require circuit board wiring between the controller IC and a series of phase ICs, which directly control the switching of the output switching stages providing the output voltage V_{OUT}. Each output stage is a buck converter.

According to the invention, as shown in FIG. 4, a circuit board 10 includes a controller C for wirelessly communicates with phase ICs Ø₁, Ø₂, Ø₃, and Ø₄. The controller C includes a transmitter/receiver (T/R) which provides RF signals to a plane polarized antenna AC, preferably designed for two-way communication.

The phase ICs Ø₁, Ø₂, Ø₃, and Ø₄, likewise have antennas A1-A4 for communicating with the controller and antennas A5-A12 for communicating with gate drivers A-H having antennas AR1-AR8. Alternatively, a single or two antennas may be used on each of the phase ICs Ø₁, Ø₂, Ø₃, and Ø₄, instead the illustrated antennas A1-A12. The phase ICs Ø₁-Ø₄ use the antennas A1-A12 to receive control information from the controller C, use the received information to control their respective output stages S1 to S4, receive feedback information, e.g., voltage indication signals x1-x8 for voltage regulation, from the respective output stages S1 to S4, and provide the feedback information back to the controller C. Each output stage is illustrated to have two switches Q1-Q2, Q3-Q4, Q5-Q6, and Q7-Q8.

After receiving the control information from the controller C, using for example, the antennas A1-A4, the phase ICs may, using, for example, the antennas A5-A12, in accordance with the control information, turn on respective buck converter output stages S1 to S4 as necessary to supply the desired output voltage. For example, the buck converter output stages S1 to S4 may be turned on in a phased relationship so that the output load current is shared amongst the phases at different instants in time, thereby reducing output capacitor and switch size requirements and reducing stresses on the switching stages.

Each switch Q1-Q8 of the buck converter output stages S1 to S4 includes a transmitter/receiver T/R-A to T/R-H for receiving the ON/OFF PWM signals for controlling the output voltage and for transmitting feedback signals, e.g., inductor current and output voltage V_{OUT} back to the respective phase chip Ø₁, Ø₂, Ø₃, Ø₄ or controller chip C.

All antennas are plane polarized in the plane of the board substrate 10 or IC substrate 10 so they do not interfere with other boards or substrates in different places.

It should be understood that while only one controller, four phase IC chips, and four output stages are shown in the drawing, there could be more or fewer of these components, as determined by their particular application.

Moreover, as shown in FIG. 5, while the controller C wirelessly communicates with drivers or phase ICs Ø₁, Ø₂, Ø₃, and Ø₄, the phase ICs may have wired connections to the switches Q1-Q8 of the output stages S1 to S4. Thus, as described above, the phase ICs may wirelessly receive the control information from the controller C and control their respective output stages S1 to S4 through the wired connections to the control electrodes A-H of the switches Q1-Q8 comprised in the respective output stages S1 to S4. Similarly, feedback information, for example, voltage indication signals x1-x8, sent by the output stages may be received by the phase ICs through the wired connection and wirelessly provided or forwarded using the antennas A1-A4 and AC to the controller C.

Although the present invention has been described in relation to particular embodiments thereof, many other variations and modifications and other uses will become apparent to those skilled in the art. It is preferred, therefore, that the present invention not be limited by the specific disclosure herein.

What is claimed is:

1. A system comprising:
a substrate;
at least one semiconductor device having a radio frequency (RF) receiver for receiving RF signals, the at least one semiconductor device being disposed on the substrate and performing functions in response to the received RF signals; and
at least one controller having an RF transmitter, the at least one controller being disposed on the substrate and used for sending the RF signals for controlling the at least one semiconductor device.

2. The system of claim 1, wherein the at least one semiconductor device is a power switch selected from one of a MOSFET, IGBT, transistor.

3. The system of claim 1, wherein the substrate is a circuit board and the at least one semiconductor device and the at least one controller are located on and communicate within the circuit board.

4. The system of claim 1, further comprising a plurality of circuit boards and the at least one semiconductor device and the at least one controller are located on and communicate among themselves on the plurality of circuit boards.

5. The system of claim 1, further comprising a plurality of circuit boards and the at least one semiconductor device and at least one controller are located on the plurality of circuit boards and the at least one semiconductor device and at least one controller on the same circuit board communicate only within that circuit board.

6. The system of claim 1, wherein the at least one semiconductor device is formed on an integrated circuit.

7. The system of claim 1, wherein the at least one semiconductor device and the at least one controller device utilize antennas for RF transmissions.

8. The system of claim 7, wherein the antennas for RF transmissions are polarized to operate only in the plane of the substrate, thereby eliminate interference.

9. A system comprising:
a substrate;
at least one first semiconductor device disposed on the substrate and having at least one antenna for sending and receiving radio frequency (RF) signals;
at least one second semiconductor device disposed on the substrate and comprising at least one output stage; and
at least one controller having an RF transmitter and optionally a receiver having at least one antenna for sending and optionally receiving the RF signals, the at least one controller being disposed on the substrate and sending the RF signals for controlling the at least one second semiconductor device.

10. The system of claim 9, wherein the at least one controller sends the RF signals to the at least one first semiconductor device and the at least one first semiconductor device sends the signals to the at least one second semiconductor device.

11. The system of claim 10, wherein each output stage includes an RF receiver and optionally a transmitter and having at least one antenna for receiving RF control signals, the RF control signals controlling the output voltage of the at least one second semiconductor device.

12. The system of claim 11, wherein the at least one first semiconductor device is connected to the at least one second semiconductor device via RF wireless communication means and
the at least one first semiconductor device sends the RF signals to the at least one second semiconductor device.

13. The system of claim 11, wherein the at least one first semiconductor device is connected to the at least one second semiconductor device via a wired connection and
the at least one first semiconductor device sends the signals to the at least one second semiconductor device via the wired connection.

14. The system of claim 9, wherein the antennas for RF transmissions are polarized to operate only in the plane of the substrate, thereby eliminate interference.

15. The system of claim 9, wherein the at least one second semiconductor device transmits output current and/or output voltage to at least one of the first semiconductor device and the at least one controller.

16. The system of claim 9, wherein the controller is a multiphase converter controller, the first device is a phase IC of a multiphase converter, and the second device is a switching mode power supply output stage.

17. The system of claim 16, wherein the multiphase converter is a multiphase buck converter.

18. A system for controlling at least one output stage having at least first and second switches, the system comprising:
a substrate, at least one controller, at least one driver, and the at least one output stage on the substrate;
the at least one controller and at least one driver, each having at least one radio frequency (RF) transmitter and optionally receiver and at least one antenna for sending and optionally receiving RF signals,
wherein the at least one controller sends the RF signals to the at least one driver for controlling the switches of the at least one output stage.

19. The system of claim 18, further wherein the at least one driver sends RF signals to control electrodes of each of the at least first and second switches via a wireless connection to control the at least one output stage.

20. The system of claim 18, wherein the at least one driver sends signals to the control electrodes of each of the at least first and second switches via a wired connection to control the at least one output stage.
